(19) United States
(12) Patent Application Publication
(10) Pub. No.: US 2015/0278203 A1
(43) Pub. Date: Oct. 1, 2015

(54) SYSTEM AND METHOD FOR MARK-UP LANGUAGE DOCUMENT RANK ANALYSIS

(71) Applicant: SOLE SOLUTION CORP, Malvern, PA (US)

(72) Inventors: Haim BARAD, Zichron Yaakov (IL); Marina GRECHUHIN, Ganei Tikva (IL); Jonathan SKELKER, Zichron Yaakov (IL)

(21) Appl. No.: 14/610,317

(22) Filed: Jan. 30, 2015

Related U.S. Application Data
(63) Continuation of application No. 13/742,763, filed on Jan. 16, 2013, now abandoned.
(60) Provisional application No. 61/586,843, filed on Jan. 16, 2012.

(51) Int. Cl. G06F 17/30

(52) U.S. Cl. CPC G06F 17/30011; G06F 17/30864; G06F 17/30598; G06F 17/3053

(57) ABSTRACT

A system and method for mark-up language document rank analysis that may be performed automatically and that may also determine one or more differences between mark-up language documents with regard to their relative rank.

This application claims priority from U.S. Provisional Application No. 61/586,843, filed on Jan. 16, 2012 which is hereby incorporated by reference as if fully set forth herein.

### FIELD OF THE INVENTION

The present invention is of a system and method for mark-up language document rank analysis, and in particular but not exclusively, to such a system and method that is useful for determining one or more differences between mark-up language documents with regard to their relative rank.

### BACKGROUND OF THE INVENTION

Search engines play important roles for supporting user interactions with the Internet. Search engines often act as a “gateway” to the Internet for many users, who use them to locate information of interest as a first resource. They are practically indispensable for negotiating the many billions of web pages that form the World Wide Web.

Many users typically review only the first page or first few pages of search results that are provided by a search engine. For this reason, owners of web sites alter their web pages to increase their rank, whether by making the pages more “friendly” to spiders or by altering content, layout, tags and so forth. This process of changing a web page to increase its rank is known as SEO or “search engine optimization”.

Currently search engine optimization is typically performed manually. Search engines carefully guard their rules and algorithms for determining rank, both against competitors and also to avoid “spam” web pages which do not provide useful content but which seek only to have a high ranking, for example to attract advertisers. However, manual analysis and adjustments are highly limited and may miss many important improvements to web pages that could raise their rank in search engine results. Additionally, manual SEO is a complex and skilled task not typically known to the writers of internet content.

### SUMMARY OF AT LEAST SOME ASPECTS OF THE INVENTION

The background art does not teach or suggest a system and method for mark-up language document rank analysis that may be performed automatically and that may also determine one or more differences between mark-up language documents with regard to their relative rank.

The present invention overcomes these drawbacks of the background art by providing, in at least some embodiments, a system and method for mark-up language document rank analysis that may be performed automatically and that may also determine one or more differences between mark-up language documents with regard to their relative rank.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative non-limiting system according to some embodiments of the present invention;

FIG. 2A shows the operation of an analysis subsystem according to at least some embodiments of the present invention, which may optionally relate to the analysis subsystem of FIG. 1, in more detail, while FIG. 2B shows an exemplary decision boundary in an exemplary two dimensional feature space;

FIG. 3 relates to an exemplary, illustrative embodiment of a lexicon generation process according to at least some embodiments of the present invention;

FIG. 4 relates to an illustrative, exemplary non-limiting method for determining stop words that are relevant to a particular lexicon;

FIG. 5 relates to a non-limiting, illustrative example of a method of partitioning a document by spans in accordance with lexicon weight for key phrase analysis;

FIG. 6 relates to a non-limiting, illustrative method for a non-intrusive, non-invasive method to intercept dynamic application data for monitoring and analysis;

FIG. 7 relates to a non-limiting, illustrative method for providing efficient suggestions for changing a mark-up language document; and

FIG. 8 relates to a non-limiting method according to at least some embodiments of the present invention for enabling a business owner to determine a geographical area on which he/she should focus for that business' webpage.

### DESCRIPTION OF THE PREFERRED EMBODIMENTS

The present invention is, in at least some embodiments, of a system and method for mark-up language document rank analysis that may be performed automatically and that may also determine one or more differences between mark-up language documents with regard to their relative rank.

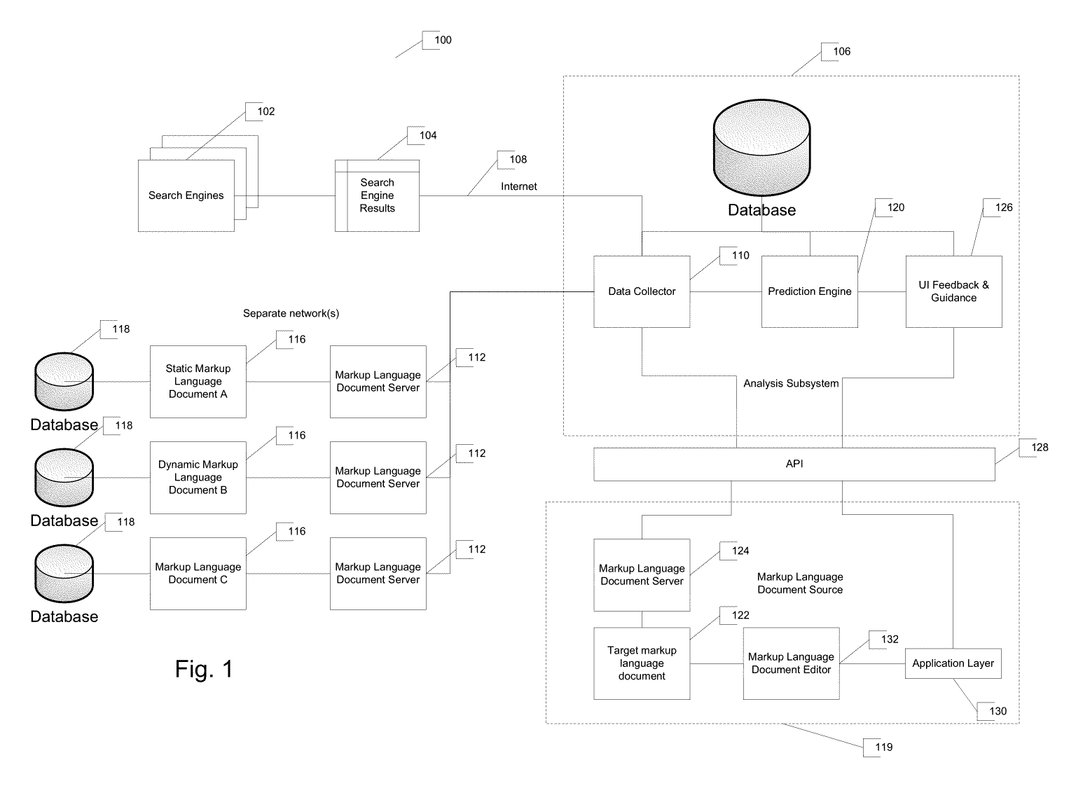

Referring now to the drawings, FIG. 1 shows an exemplary, illustrative non-limiting system according to some embodiments of the present invention. As shown, a system 100 features a plurality of search engines 102 as non-limiting examples of computer network based indexing programs for indexing mark-up language documents, which are preferably internet based indexing computer programs for indexing such mark-up language documents. Such programs assist users to locate content based upon one or more parameters such as keyword searches for example, typically by using indexes of mark-up language documents such as web pages for example. Typically search engines 102 return a plurality of mark-up language document results by returning a plurality of links to such documents to a computer of the requestor of the search, such as for example a plurality of URLs. Search engines 102 are shown in FIG. 1 as returning a plurality of search results 104 to an analysis subsystem 106 through a computer network 108, which may optionally be the internet for example. Analysis subsystem 106 is typically operated by one computer or a plurality of computers, and/or through distributed computing, as non-limiting examples.

Analysis subsystem 106 optionally and preferably receives such search results 104 in response to a query, which is preferably formatted as for any search engine query (for example, containing one or more keywords). The query is preferably generated and transmitted by a data collector 110, which also receives search results 104.

Data collector 110 also preferably obtains the mark-up language documents associated with search results 104, for example by downloading such documents from a server. As non-limiting examples, data collector 110 is shown as being in communication with a plurality of mark-up language document servers 112 through a computer network 114, which may optionally also be the Internet and/or otherwise the same computer network as computer network 108. Data collector 110 preferably receives one or more mark-up language documents 116 according to the search results 104, for example according to a URL or other address for a particular mark-up language document server 112, which is supplied with search results 104. Data collector 110 may optionally retrieve or “pull” a mark-up language document 116 or alternatively may have such a mark-up language document 116 “pushed” or sent to data collector 110.

Each mark-up language document server 112 is shown as providing a different type of mark-up language document 116 (although of course each server 112 may or may not be limited to a particular type of mark-up language document 116), with non-limiting examples including a static mark-up language document A 116, a dynamic mark-up language document B 116 or a mark-up language document C 116. Each mark-up language document server 112 optionally retrieves each such mark-up language document 116 from a database 118 as shown.

Data collector 110 then preferably passes these results and one or more of the above described mark-up language documents 116 to a prediction engine 120, which as shown is also part of analysis subsystem 106. As described in greater detail below, prediction engine 120 then analyzes the received search results 104 and also the corresponding mark-up language documents 116 with regard to the relative ranking of a plurality of mark-up language documents 116, and also by comparing one or more features within the plurality of mark-up language documents 116 according to their relative rank.

Additionally or alternatively, prediction engine 120 may also optionally compare one or more features of a target mark-up language document 122 to such one or more features in mark-up language documents 116, with regard to a relative rank of target mark-up language document 122 in comparison to mark-up language documents 116, as determined in search results 104.

Target mark-up language document 122 is preferably provided by a target mark-up language document source 119, which preferably comprises a target mark-up language document server 124. Target mark-up language document server 124 is preferably in communication with data collector 110, preferably through an API (application programming interface) 128, and also optionally through any computer network 106 as previously described (alternatively, target mark-up language document server 124 may optionally be in direct communication with data collector 110, for example through an internal network and/or as part of a particular computational hardware installation). Data collector 110 may optionally “pull” target mark-up language document 122 from target mark-up language document server 124 or alternatively may have target mark-up language document 122 “pushed” by target mark-up language document server 124.

The comparative analysis of target mark-up language document 122 with regard to mark-up language documents 116 is described in greater detail below, but preferably includes determining at least one difference between target mark-up language document 122 and mark-up language documents 116 with regard to relative rank. Optionally such a difference could for example explain a relatively lower rank of target mark-up language document 122 with regard to one or more mark-up language documents 116.

The results of the analysis may optionally be adjusted according to feedback from a user, which provided through a UI feedback and guidance module 126.

Analysis subsystem 106 is optionally in communication with one or more additional external computers or systems, which is preferably performed through one or more APIs (application programming interfaces) 128. In this exemplary system 100, API 128 supports communication between UI feedback and guidance module 126 and an application layer 130, which for example may optionally support a user interface (UI, not shown) for communication with UI feedback and guidance module 126.

Target mark-up language document source 119 also preferably features a mark-up language document editor 132, which may either optionally perform one or changes on target mark-up language document 122 automatically or alternatively (or additionally) according to one or more user inputs, for example through application layer 130. For example, UI feedback and guidance module 126 may also optionally provide inputs as to one or more proposed changes to target mark-up language document 122 to increase the relative rank of target mark-up language document 122 with regard to the plurality of mark-up language documents 112 obtained in the search results. Such inputs are preferably provided to application layer 130, whether for user approval or for automatic implementation by mark-up language document editor 132.

Alternatively or additionally, the user may perform one or more changes to target mark-up language document 122, whether through application layer 130 or directly through mark-up language document editor 132, after which the changed document is reanalyzed by prediction engine 120, to see whether the expected relative rank would be higher or lower, as described in greater detail below.

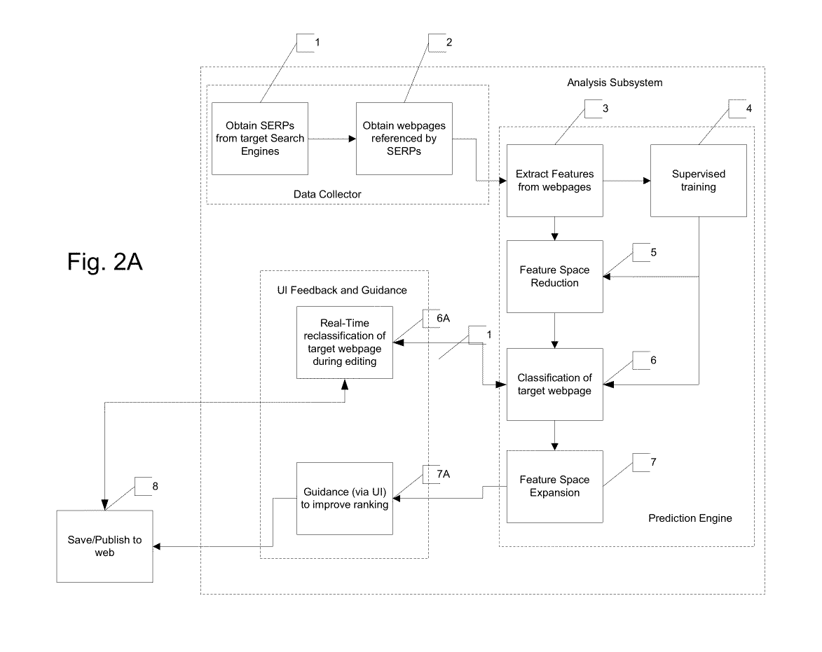

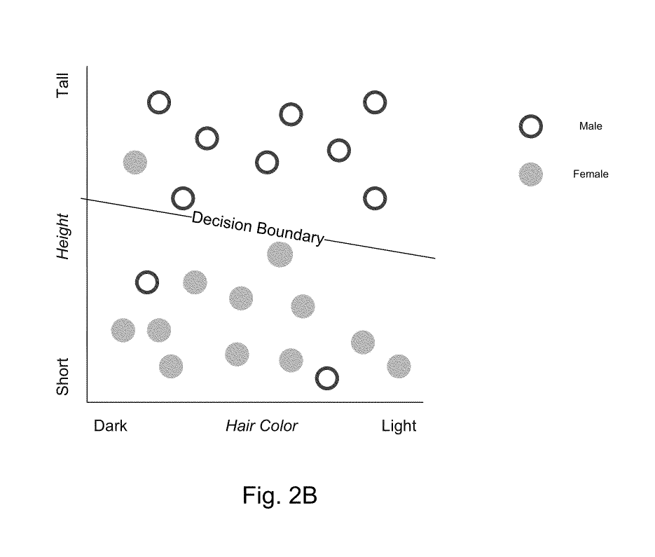

FIG. 2A shows the operation of an analysis subsystem according to at least some embodiments of the present invention, which may optionally relate to the analysis subsystem of FIG. 1, in more detail. As shown, in stage 1, data collector obtains the search results from one or more search engines. In stage 2, data collector obtains the mark-up language document pages, such as web pages for example, according to the search results; for example and without limitation, the search results may include URLs or other address information for the mark-up language documents. For this exemplary method and without wishing to be limited, the description will relate to web pages as the mark-up language documents.

Stages 3-7 are then performed by the prediction engine. In stage 3, the prediction engine extracts one or more features from the web pages as described in greater detail below. In stage 4, the prediction engine preferably performs supervised training of an analysis algorithm with regard to such features.

Supervised training is a machine learning methodology whereby examples from a known set of classes are fed into a system with the class identifiers. Often the input samples are in the form of an N-dimensional feature vectors. The system is trained with these samples and class identifiers and the resultant model is called a classifier.

Ideally, the classifier should be able to classify the entire training set (now without the given class identifiers) correctly. The entire process of learning from a set of sample feature vectors is called “training the classifier”.

Once training is complete, the classifier is then used to classify unlabeled data into classes. This can be done through a variety of methods that typically rely on determining relative similarities between classes (as determined during training) and the new input vectors.

A simple example of supervised training is the ability to distinguish between males and females based on just two features. The first feature is height and the second feature is hair color. Clearly from a priori knowledge, it is known that height is more likely to be a usefully distinguishing feature than is hair color. The process starts by obtaining training samples from a selected and known training set of male and female participants. A feature vector (2-dimensional) is extracted from each of the training samples and plotted in a two-dimensional feature space, with one dimension for each feature. As seen from the example (FIG. 2b), the male population tends to be taller (that is, the male and female populations may be more accurately separated by height) and a decision boundary is calculated for the feature of “height”. While the separation between the two classes is not 100% accurate, it is possible to classify new samples with reasonable accuracy. For greater accuracy, it would be necessary to enhance the classifier by adding new features. In any case, the classifier can be used now to classify unknown samples based on the calculated decision boundary.

The main advantage of supervised training is the construction of the classifier is often more accurate and reliable than for unsupervised training, because the training set had a known set of class identifiers. For the presently described method, it is possible to leverage supervised training methods because the search engines provide the rankings in the Search Engine Result Pages. The supervised training is not limited to training by search engine rankings but may instead optionally include other classification information for training purposes.

In stage 5, the prediction engine optionally performs reduction of the dimensionality of the feature space, to locate one or more features considered to be of particular importance in determining the relative rank of the target after the supervised training. Therefore, subsequent stages may optionally be performed with lower dimensionality. Non-limiting examples of algorithms for feature space reduction include PCA (principle component analysis).

In stage 6, the prediction engine classifies the target web page according to the N dimensional feature space and according to the decision boundary. Optionally one or more features are weighted with regard to its respective decision boundary such that in cases where the classification of the target web page with regard to that feature is not clear, the decision may optionally be weighted toward a particular side of the boundary. Weights on each feature determine the decision boundary which may for example optionally be characterized by a multidimensional hyperplane or other methods of segmenting the feature space, or for example through application of decision tree logic. In stage 7 the prediction engine then performs feature space expansion in which the engine determines which features have the most effect on altering the rank of the target web page with regard to the other ranked web pages.

Optionally stages 5 and 6 are not performed, for example if the method is not to be performed in real time, in which case the method optionally proceeds from stage 4 directly to stage 6A as described below.

From stage 6 the process may also optionally be performed by the UI feedback and guidance module in stage 6A, which may optionally perform real time reclassification of the target web page according to input through the web page editor. Also from stage 7, the process may also optionally be performed by the UI feedback and guidance module in stage 7A, which may optionally provide guidance to the user (or to an automated web page editor) with regard to whether one or more changes are likely to improve or reduce the rank of the web page with regard to the other analyzed web pages.

In stage 8, optionally such information is provided to the user and/or through the web; for example, optionally the altered webpage is published to the Internet by being uploaded to a web server.

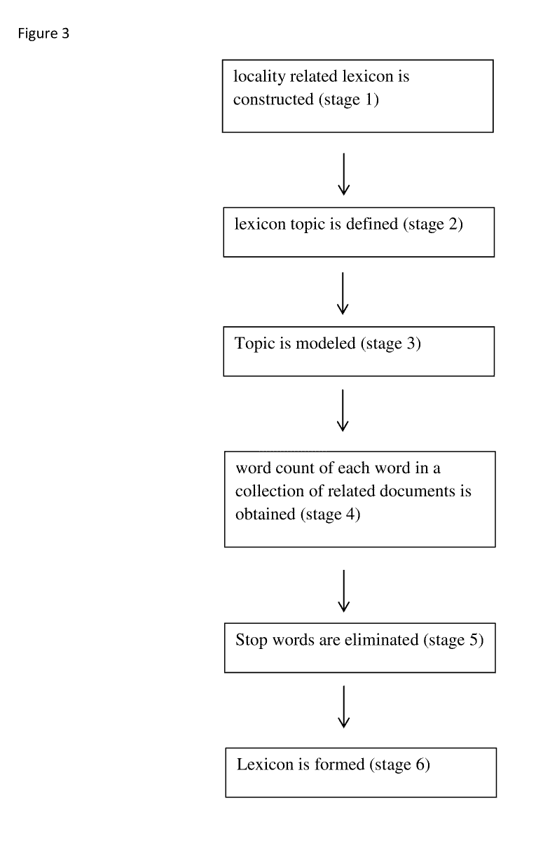

FIG. 3 relates to an exemplary, illustrative embodiment of a lexicon generation process according to at least some embodiments of the present invention.

In stage 1, a locality related lexicon is constructed, which is specific for a particular locality. The determination of a locality as such is made by using parameters in the query to the search engine that specify the locality. Optionally, a variety of parameters are considered but only those which cause a substantive difference in the response by the search engine to a given query. By “locality” it is not necessarily meant a physical location but rather a language based location, which would typically incorporate language and cultural factors (the latter would typically be language based, for example relating to slang or language constructs based upon cultural expressions). For example, English is spoken in both London and New York City, yet London-based English would have a separate locality related lexicon than New York City-based English. Furthermore, a user physically based in London might still prefer or need to use the New York City-based English locality lexicon. Parameters provided to the search engine may optionally directly refer to the locality (for example, “UK English” as opposed to “US English”, or even with a more specific reference) or alternatively may optionally be derived from language that is known to be related to such a language based location.

In stage 2, a lexicon topic is defined. The lexicon topic is defined by querying the search engine for related pages (typically either according to one or more search phrases or alternatively through a clustered approach such as a news portal). With regard to the latter, some search engines (including the Google engine) determine that certain news stories have a theme and “cluster” them together. Such search engines return multiple links as a story cluster, such that within the cluster, all articles relate to the same news story that the search engine has determined is relevant to the search query. In other cases, dedicated web pages may bring together related information, links or stories that have been “curated” and determined to be related, whether manually or automatically.

Once these related pages are identified, words in common usage make up the lexicon. As used herein but without wishing to be limited, lexicon words in a topic are those words that appear frequently in documents related to a specific topic, but not as common in documents that are distant from that topic. In other words, search engine results are ordered by relevance, hence the words that occur more frequently in the higher ranking documents are more on topic for the purpose of constructing the lexicon.

In stage 3, the topic is modeled. By “topic modeling” it is meant any type of statistically based analysis of language related to a particular subject area or topic. The subject area may optionally be defined narrowly or broadly, but to the extent that the subject area or topic is defined more specifically, it is expected that the resultant model would capture more features of the language and/or capture them more precisely. Such modeling is preferably based on the search engine modeling of a topic and is preferably determined through providing queries to the search engine and receiving responses, which are then analyzed. For example, the topic is considered by using it as the search phrase for a particular search engine, and then analyzing the search engine results to model the lexicon usage for the topic. Optionally, different search engines may give different responses and so a topic may optionally be modeled differently for different search engines, according to their respective responses.

In stage 4, a word count of each word in a collection of related documents is obtained; in this non-limiting example, the search engine ranking results serve to determine the extent to which the documents are related (and also which documents are related), such that the training process is supervised training. Optionally and preferably, every word appearing at least once in any document has a database entry and the number of times the word appears is also recorded.

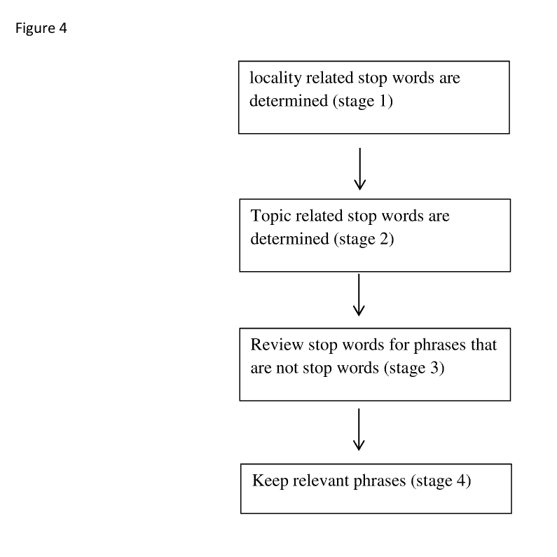

In stage 5, once the collection of words has been established, preferably any stop words are eliminated. Stop words are eliminated as they act as background noise to the topic, and do not provide any information which is relevant to the topic. A more detailed description of such a process is provided with regard to the method of FIG. 4. Stop words (i.e. words that bring no semantic relevance) are removed by learning normal distribution of words for a language across many topics. A specific topic's lexicon will have noticeably different distributions within that topic than across the normal model. Words that have high appearances across the normal model are therefore assumed to be stop words as described in greater detail below; these words can be reintroduced to a topic if for a specific topic they also have higher than usual information bearing usage. By “information bearing” usage it is meant that the words are relevant to the topic and hence provide information, as opposed to acting as background noise.

In stage 6, after stop words are removed, the most frequently appearing terms for this specific topic, preferably which do not appear frequently for other topics, form the lexicon for the topic. For example, optionally a scoring system may be used to determine which words appear in the lexicon, and optionally and preferably also determines the ordering of the words in the lexicon.

Such a scoring system may optionally comprise determining the number of documents in which the lexicon term appears for the topic under consideration (“NumDocs”) and multiplying by the average number of occurrences of this term per document (again, within the context of this topic; “AvgOccur”). However, such a simple calculation could enable a frequently occurring (but otherwise irrelevant) word to be selected. To help prevent such an artifact, preferably the highest ranking document in which the term occurs is determined (HighRank) and the score is adjusted accordingly: Score=(NumDocs*AvgOccur)/HighRank. HighRank refers to the rank of the highest place document that contains this term, with 1 being the highest. By dividing by this parameter, a word that only appears frequently in low ranking documents will not get a higher score than a word which occurs less frequently but in the higher ranking documents.

The division by the HighRank ensures that the rank or relevancy of the document is also considered, thereby preventing a non-relevant word that appears more frequently in low ranking documents from being selected.

FIG. 4 relates to an illustrative, exemplary non-limiting method for determining stop words that are relevant to a particular lexicon. Such a method may optionally be used with regard to the method of lexicon generation of FIG. 3, for example.

In stage 1, locality related stop words are determined Such stop words are those words which, given a particular language and location, appear frequently in all documents, regardless of topic (“and”, “the”, “a”, “an”, “is”, and so forth). The determination of which words are “stop words” is typically language dependent; for example, the stop words may optionally be taken from a list of known stop words in a particular language. However, preferably rather than relying on prebuilt dictionaries of stop words, the collection is generated by analyzing large amounts of content (such as websites for example) to determine words that appear frequently across all topics.

In stage 2, potentially topic related stop words are obtained from the previously described set of documents that are used to determine the topic specific lexicon, for example by determining which words appear with a statistical frequency that is greater than a threshold. For example, this process may optionally be used to reintroduce stop words that are in fact semantically relevant for a specific topic, e.g. the word “can” is generally a stop word, but for the topic “tuna” it could be part of a topic model (as in “can of tuna”). This actual relevancy, as opposed to removing the word as a stop word, would optionally and preferably be determined by identifying significant additional usage beyond its generic frequency determined when building the original list of stop words.

In stage 3, both sets of stop words are reviewed for combinations into phrases of two or more words that are considered to be important to a topic, or even for single words that may be important to a topic. As noted above, this process may optionally be performed automatically.

In stage 4, optionally phrases comprising such stop words (“for sale”) are not eliminated if the phrase itself is determined to be important. Furthermore, even single stop words may be accepted as previously described if important to a topic.

Optionally stages 3 and 4 may be performed according to the following analysis. N-grams often are composed of stop words yet may in fact be important words or phrases. For example “New York” contains a stop word “new”—but when combined with York, the combined 2-gram is not a stop word. To determine that a word or phrase is not a stop word, it is important to search for single words or phrases that appear in a topic with a high frequency but which do not appear in other topics with the same or similar frequency. By contrast, stop words have similar frequency across topics.

Topics are optionally and preferably modeled by observing the frequency of singleton terms and n-grams, hence a phrase like New York might reappear enough to be recognized as part of the topic model. To keep the lexicon clean, if n-grams of different size can be contained in each other and have the same score, only the largest is displayed; for example if New York and New York City all appeared with the exact same frequency one would preferably only include New York City in the lexicon. Note that New would likely have a higher occurrence than New York and New York City, but that once New's occurrence has been normalized based on its generic frequency across lexicons (i.e. that it is a stop word) it would be unlikely to have a high enough occurrence to appear in the lexicon as a single term.

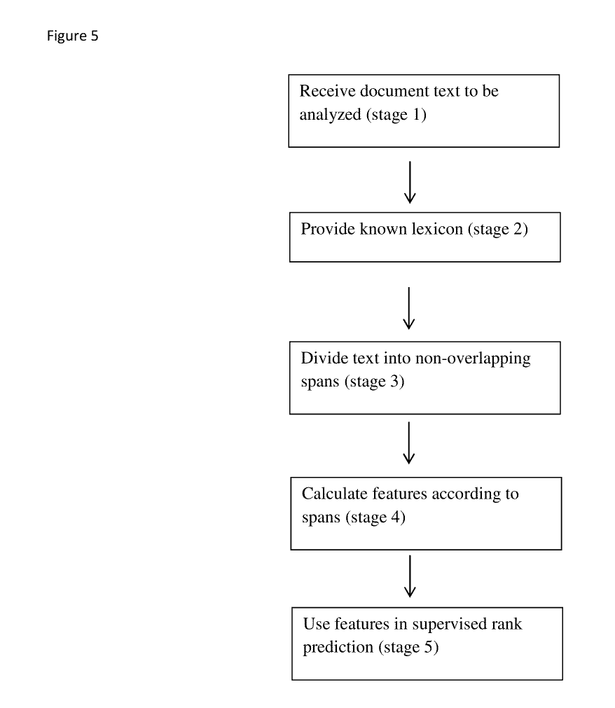

FIG. 5 relates to a non-limiting, illustrative example of a method of partitioning a document by spans in accordance with lexicon weight for key phrase analysis.

The division of a document into separate non-overlapping portions of text (“spans”) was developed and used by Svore et al (“How Good is a Span of Terms? Exploiting Proximity to Improve Web Retrieval”; SIGIR′10, Jul. 19-23, 2010, Geneva, Switzerland; which is hereby incorporated by reference as if fully set forth herein) based on occurrences of words in the exact search phrase. However, Svore's method was rigid and inflexible, and did not consider the importance of a particular lexicon to determine the best spans for analysis. The illustrative method described herein overcomes these drawbacks of the background art by using a full lexicon of relevant words for span calculation and by using features based on lexicon span characteristics as important features in rank prediction, neither of which was taught or suggested by Svore.

In stage 1, a document text to be analyzed is received. Preferably, the text is not in mark-up language form but rather is in the form read by the user, with words, sentences and so forth. If mark-up language formatting is present, it is preferably removed before analysis.

In stage 2, a known and predetermined relevant lexicon is provided for the document. Such a lexicon is preferably provided according to the topic of the document.

In stage 3, the text is divided into a series of non-overlapping spans based on the amount of lexicon usage within that span. Optionally and preferably, a span is initiated and continues until the weight of the lexicon terms within the span exceeds some threshold. The threshold can be a total lexicon score which is calculated by summing the lexicon scores (as defined above based on the topic model scores) for the words from the start of the span. Once the scores of the words from the start of the span reach this threshold, the span can be closed. The threshold is adjustable and can be used to define multiple span features which represent different densities of lexicon usage within the documents.

Once the threshold is exceeded, a new span starts with the occurrence of the next lexicon word in the document. Optionally, a maximum number of words may be set for the length of a span, even if the weight has not been exceeded. In any case, the spans do not have a preset length of words, unlike other art known span calculating methods.

Short spans are typically preferred, as such short spans have many highly weighted lexicon words. Optionally, different spans of different weights/lengths may optionally be employed at different points in a document. For example, the end of an article is important and may be weak in terms of the use of lexicon words, so optionally spans may have to meet a higher threshold at this portion of the article, whether in terms of weight or maximum total number of words present (the two parameters may also optionally be adjusted in an opposing manner, so that the weight threshold increases while the maximum number of words present decreases).

In stage 4, features are then calculated based on the characteristics of those spans (e.g. average length, maximum length, crossing of sentence and paragraph boundaries, % of words outside of spans, etc. These features are calculated directly from measurements of the text (e.g. average length of spans are calculated by summing the span lengths and dividing by the total number of spans in the page.).

In stage 5, the calculated features are used in supervised rank prediction based upon the target search engine's behavior. Spans are useful in that they give indications as to the “richness” of the text against the distribution (by location) of the text. Consider a portion of the document where people list keywords or tags—that section is very rich and often a search engine might want to ignore that area as it seems like unnatural listing of keywords. On the other hand, a well written document that is rich in information and reads well will have a more uniform distribution of terms which can be indicated by a well distributed collection of spans with few weak areas and no artificially dense areas. Spans are a useful feature in document rank prediction; improvements in spans (i.e.—shorter spans having more highly weighted lexicon words) may also optionally be used to improve ranking with regard to a search engine. The distance/order of words is less important.

As an example, consider the phrase “Best New York Italian Restaurants”. The word “New” is generally a stop word but not in this case, as it is next to the word “York”. If the document is a review of the best Italian restaurants in New York City, then clearly the proximity of these words to each other—but not their order—is important and would presumably occur within a single highly weighted span. If the restaurant was not identified as Italian it might still be considered to be relevant if various “Italian food words” were used, such as for example pasta, pizza, certain types of dessert (cannoli) and so forth. These words would again be likely to occur at high density in a well written document about this subject.

On the other hand, a review of a restaurant of another type that happens to be in an Italian neighborhood would have spans with very different characteristics; even though the word “Italian” might appear in the document, the document would not score highly on the “Italian restaurant” lexicon. Thus, spans may also optionally be used to distinguish different types of documents having different lexicons.

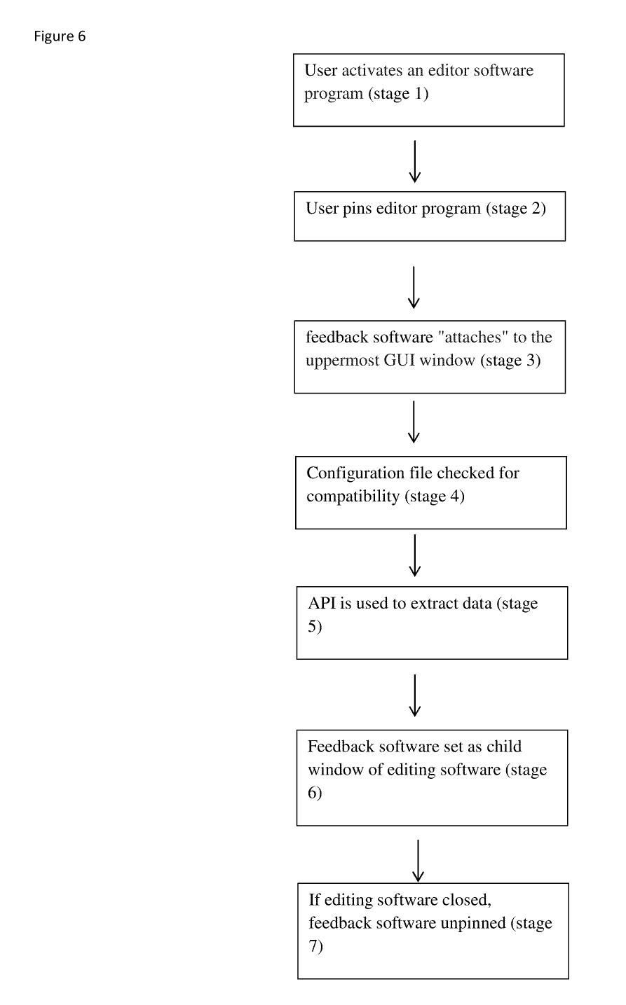

FIG. 6 relates to a non-limiting, illustrative method for a non-intrusive, non-invasive method to intercept dynamic application data for monitoring and analysis.

Pinning removes the need for users to install multiple plugins into various applications to provide them with the same functionality. Instead a single application can then be “pinned” to supported applications on an ad-hoc basis and interact with it to provide the functionality required Pinning is achieved by identifying the OS (operating system) process the application is attached to and then to hook to it to receive the required data. An example is reading the text in different text editors to examine how relevant it is for a specific topic model. A pinning application can be attached to an editor application, such that the OS process of this editor application that it is intercepting is identified; depending on the process, an application specific hook is called to read the text in the editor. The relevancy of the text is then always displayed in the same pinning application regardless of the editor being used. This method may optionally be used to support the user feedback and guidance method as described herein.

In stage 1, the user opens or activates an editor software program of their choice. Although this method relates to a software program being operated by the Windows® operating system (Microsoft Inc, Redmond Wash.), it is understood that this description is not intended to be limiting in any way. One of ordinary skill in the art could easily adapt this method for other types of software and/or computer operating systems.

In stage 2, the user “pins” the editor program by clicking on the red drawing pin button or otherwise indicating that the user wishes to invoke the user guidance and feedback module as described herein.

The feedback software then “attaches” to the uppermost. GUI (graphical user interface) window (excluding any windows associated with the feedback software itself and a list of exception windows for specific software programs below) in stage 3. The OS can be running multiple software programs as the same time. It is possible to assume that the user is attaching (pinning) to the application that is currently visually “on top” or otherwise in focus. However a black list of applications to be excluded is preferably determined since some monitoring software or screen sharing software always runs on top of every other application (even if they aren't actually visible to the user).

This code snippet demonstrates the calls to the windows API to identify the active window to pin to.

```
[DllImport(“user32.dll”, ExactSpelling = true, CharSet = CharSet.Auto)]
    public static extern IntPtr GetParent(IntPtr hWnd);
  [DllImport(“user32.dll”)]
    static extern int EnumWindows(WNDENUMPROC lpEnumWindow,
uint lParam);
    [DllImport(“user32.dll”)]
    static extern int GetWindowLong(IntPtr hwnd, int nIndex);
    const int GWL_EXSTYLE = −20;
    const uint WS_EX_TOOLWINDOW = 0x0080;
    [DllImport(“user32.dll”)]
    public static extern int GetWindowThreadProcessId(IntPtr hWnd,
out int ProcessId);
  public static bool ApplicationToPinSelected( )
    {
      m_Count = 2; //Taking the second window, the one that was
active just before “Pin” was clicked
      EnumWindows(new WNDENUMPROC(Callback), 0);
      return m_LastActiveWindow != IntPtr.Zero;
    }
  static int Callback(IntPtr hwnd, uint lParam)
    {
      bool hasOwner = GetParent(hwnd) != IntPtr.Zero;
      bool visible = IsWindowVisible(hwnd);
      bool isToolWindow = (GetWindowLong(hwnd,
GWL_EXSTYLE) & WS_EX_TOOLWINDOW) != 0;
      if (!hasOwner && visible && !isToolWindow)
      {
        if (m_Count == 0)
        }
          return 1;
        }
        m_LastActiveWindow = hwnd;
        m_Count −= 1;
      }
      return 1;
    }
```

In stage 4, the configuration file of the editing software program is checked to determine whether the editing software process may be “pinned” to the feedback module software. Once the process to be pinned to has been identified, the configuration file is checked for the existence of a hook that can access the data in that application.

```
Configuration:
<PinApplicationConfiguration TemporaryPath=“”>
  <PinApplications>
    <clear />
    <add WindowClass=“Internet Explorer_Server” Application=“iexplore”
    ConnectorTypeFullyQualifiedName=“BabySEO.Connectors.InternetExplorer.
InternetExplorerConnector, BabySEO.Connectors” />
    <add WindowClass=“_WwB” Application=“winword”
    ConnectorTypeFullyQualifiedName=“BabySEO.Connectors.WordProcessing.
WordProcessingConnector, BabySEO.Connectors” />
    <add WindowClass=“OpusApp” Application=“winword”
    ConnectorTypeFullyQualifiedName=“BabySEO.Connectors.WordProcessing.
WordProcessingConnector, BabySEO.Connectors” />
    <add WindowClass=“Chrome_WidgetWin_0” Application=“Chrome”
    ConnectorTypeFullyQualifiedName=“BabySEO.Connectors.Chrome.ChromeC
onnector, BabySEO.Connectors” />
    <add WindowClass=“Chrome_WidgetWin_0” Application=“RockMelt”
    ConnectorTypeFullyQualifiedName=“BabySEO.Connectors.Chrome.ChromeConnector,
BabySEO.Connectors” />
    <add WindowClass=“MozillaWindowClass” Application=“Firefox”
    ConnectorTypeFullyQualifiedName=“BabySEO.Connectors.DDEBrowser.
DDEClientConnector, BabySEO.Connectors” />
    <add WindowClass=“OperaWindowClass” Application=“Opera”
    ConnetorTypeFullyQualifiedName=“BabySEO.Connectors.DDEBrowser.
DDEClientConnector, BabySEO.Connectors” />
    <add WindowClass=“Notepad” Application=“Notepad”
    ConnetorTypeFullyQualifiedName=“BabySEO.Connectors.Notepad.Notepad
Connector, BabySEO.Connectors” />
  </PinApplications>
  <ExcludeApplications>
    <add WindowClass=“#32770” Application=“Windows Task Manager” />
    <add WindowClass=“join.me” />
    <add WindowClass=“TCallMonitorForm” Application=“Skype Screen Sharing”
/>
  </ExcludeApplications>
  </PinApplicationConfiguration>
```

In stage 5 after identifying the editor process type (Notepad, Word, Iexplorer, etc.), the appropriate proprietary API (application programming interface) is used to extract the data for “pinning” the software. The APIs are per ApplicationIdentifier and ContentIdentifier (e.g. unique url, and content). For example, a user may have multiple instances of the same application open, yet be pinning to a specific instance, e.g., a browser based editor, so in that case the API is supplied with identification of the application, same Google Chrome or MS Word and then from which instance of the application content is to be monitored, for example according to URL or file name. Each supported process has an implemented interface for data retrieval.

Non-limiting examples are given below with regard to specific examples of editor software programs that are known to be operated by the Windows® operating system; clearly one of ordinary skill in the art could adapt the below methods for different editor software programs.

a. Notepad: this code can read the text in notepad directly from the process information:

```
    [DllImport(“user32.dll”, SetLastError = true, CharSet =
CharSet.Auto)]
    public static extern IntPtr FindWindowEx(IntPtr parentHandle,
IntPtr childAfter, string lclassName, string windowTitle);
Process notepadProcess =
Process.GetProcessById(activeWindow.ProeessId);
    if(notepadProcess.MainWindowHandle == IntPtr.Zero)
    {
      return null;
    }
    IntPtr hwnd = new IntPtr(0);
    IntPtr parent = new IntPtr(notepadProcess.MainWindowHandle.-
    ToInt64( ));
    IntPtr child = FindWindowEx(parent, hwnd, “Edit”,“”);
```

b. Word—this process uses Word Interop API

m_WordApp=(Application) Marshal.GetActiveObject(“Word.Application”);

For some editor software programs, the data is only available on a server via a server API. Examples include browser based CMS systems like Joomla, etc. The ApplicationIdentifier and ContentIdentifier then refer the feedback module to communicate to the suggestion server (the hosted server to which the feedback module sends page data for processing and from which it receives suggestions). The feedback module then starts extracting data from the server (according to the specific connector) rather than receive the data via the windows application and the user GUI client.

In stage 6, the feedback module software process is then set as a child window of the selected window, so that they move together (minimise etc.).

If the editing software parent window is closed in stage 7, the feedback module software automatically detaches itself from the process. If the pinned to process is closed, then the connection between the pinning application and the process is closed as well (it is no longer a child process of the closed process).

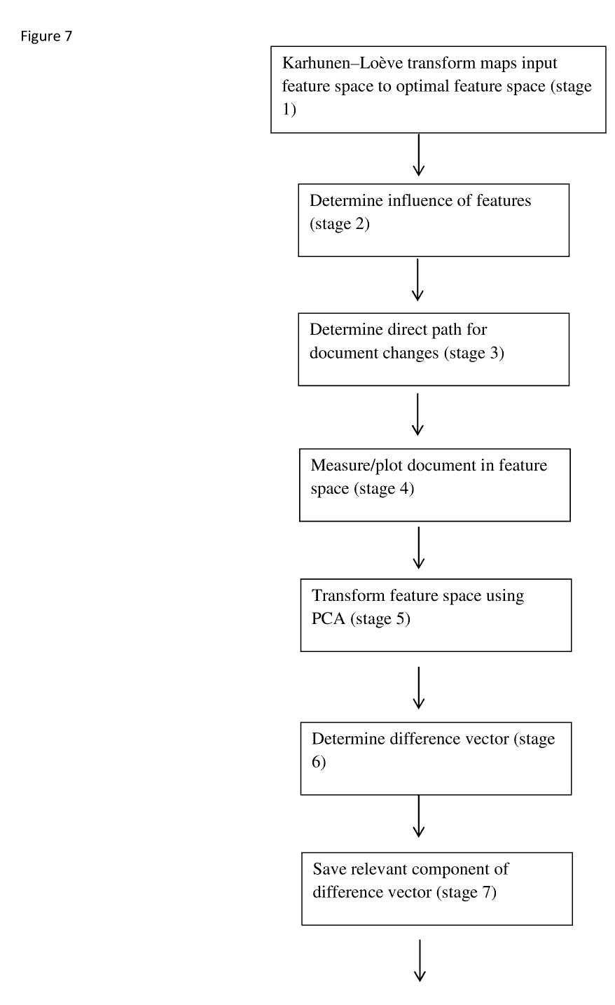

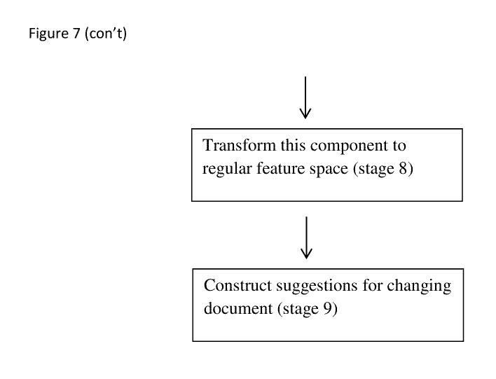

FIG. 7 relates to a non-limiting, illustrative method for providing efficient suggestions for changing a mark-up language document. Without wishing to be limited in any way, this method enables the user to make relatively few (or at least relatively fewer) changes to a mark-up language document in order to achieve a desired result, such as for example an increase in rank as determined by a search engine.

Also without wishing to be limited in any way, the method described herein may optionally be performed with regard to a method of eigenvector space mapping for optimal correction via actionable suggestions. The below exemplary method is described with regard to such a type of space mapping for the purpose of description only and without any intention of being limiting.

In stage 1, a Karhunen-Loève transform maps an input feature space into a decorrelated and orthogonal feature space that is optimal (by minimizing mean squared error) with regards to dimensionality reduction. This is done by solving an eigensystem of the correlation matrix and transforming the data into this orthogonal space (one method Principal Components Analysis). We don't limit this to the Karhunen-Loève transform as other methods (Singular Value Decomposition) can be used instead. The idea here is to move into a decorrelated and orthogonal feature space to better provide improved discrimination while using a reduced feature space. This transformation is important since the input feature space suffers from correlated features and therefore movements along specific features in feature space can and will affect positions along other feature basis vectors.

In stage 2, the influence of these decorrelated features to ranking may optionally be determined, for example with regard to search engine behavior as previously described. This can be done by ordering the eigenvalues in descending of absolute value and ordering the corresponding features in the same order. Those features with largest magnitude of eigenvalues are the most useful in discrimination necessary to provide ranking, improvement suggestions, etc.

Once a ranking is determined in transformed space, a direct path can be determined to guide changes to a document to achieve an improved rank position in stage 3.

However, this direct path is not readily understood by the user, as it is determined in the transformed space, with axes that do not correspond to intuitive features (and therefore are difficult to map into actionable suggestions). The subsequent stages relate to an optionally exemplary method to decompose this optimal path into actionable suggestions so that minimal work is done to achieve top ranking.

In stage 4, the document under examination is measured, features are extracted and plotted in feature space (and a target position for high-rank is also known in feature space).

In stage 5, data in the feature space is transformed optionally using PCA (Principal Components Analysis) or one of several other transformation methods that may be used as explained previously.

In stage 6, given the transformed data for the document being written and a desired position (also transformed), a difference vector is derived which represents the changes needed in an orthogonal feature space to correct the document based on independent corrections along the transformed (orthogonal) feature space.

In order to provide a simple but highly effective set of suggestions, the component of this difference vector corresponding to the axis that corresponds to the largest eigenvalue in the transformed feature space is saved in stage 7. These suggestions (which will incrementally move the document's location in feature space) provide a set of suggestions that can be ordered from those proving the most benefit to those providing the least benefit. [NOTE: A user can later make most efficient use of his time by deciding on following the most important features first and possibly terminate his “improvement work” part way if be decides that the cost of further improvements (i.e. his time) is worth the benefit of the remaining suggestion's corresponding effect in feature space. This can be done after the inverse PCA step (see next section)]

This component of the difference vector is now transformed back into the regular feature space (inverse PCA or another inverse of the previously described method is used. This resultant vector now has components in human actionable form that correspond to changes in the document that the author can take action on (such as using more lexicon or keywords in a certain area of the document).) in stage 8.

In stage 9, the features are used to construct suggestions for the author/editor of the document.

Optionally or additionally, other types of statistical analyses may be used to analyze the web page and then to guide the author/editor to make changes as described above.

For example, such analyses may optionally use higher order, multivariate statistical analysis for determining webpage quality (and ultimately rank prediction). Higher order statistics are needed to include more complex features (e.g. skewness) and multivariate analysis is required to properly analyze the features concurrently (as opposed to looking at each feature in isolation).

Text that is natural and rich will exhibit different statistical characteristics than text that only obeys univariate statistics on word usage.

For example, many higher order features, including but not limited to entropy, variance, angular second moment, inverse difference moment, contrast correlation, difference entropy and so forth can be calculated and provide characteristics of the richness of the text (using standard measures analogous to co-occurrence matrices and other types of multivariate analysis in conjunction with these specific statistical features).

Often webpage analysis is done one feature at a time (e.g. keyword density) and isolated from other features that might be looked at in a subsequent step, thus implying that the features are orthogonal, when they clearly are not. In other words, preferably at least one statistical measure is applied which considers a plurality of language features simultaneously.

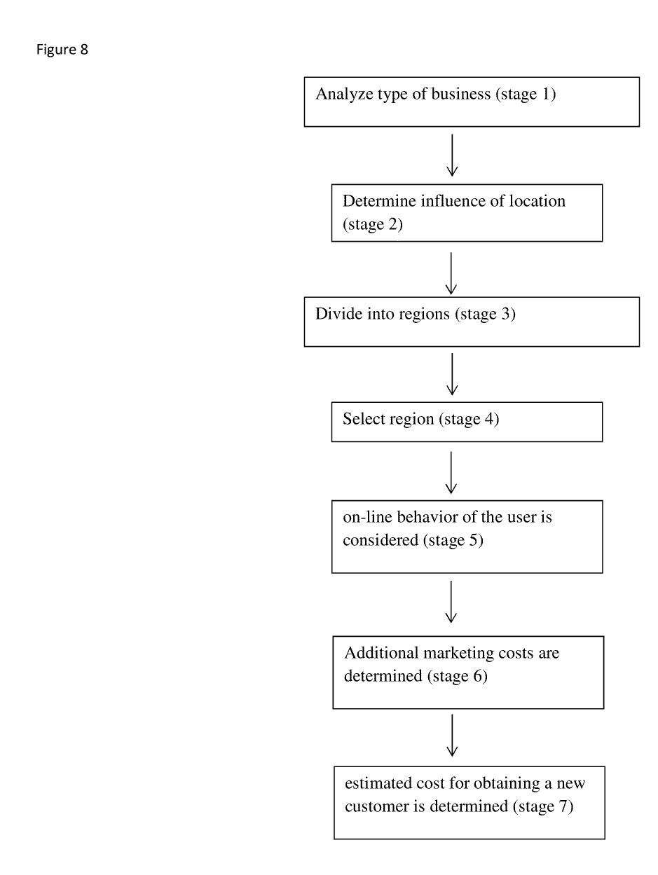

FIG. 8 relates to a non-limiting method according to at least some embodiments of the present invention for enabling a business owner to determine a geographical area on which he/she should focus for that business' webpage. Depending upon the nature of a specific business, it may be more worthwhile for the business owner to focus the webpage more or less locally to the geographic location of the business itself.

In stage 1, the nature of the business category is preferably analyzed. These factors include the type of business, whether the consumer may generally consider traveling to this type of business, and trends in popularity for specific services etc.

In stage 2, the surrounding environment (in terms of competition) is analyzed. Population density is also preferably considered; for example, outlying areas with spare population densities might not fall within the expected geographical radius but where resultantly there are very few (if any) providers of this service which would lead to consumers travelling considerably further than usually expect for that business type. Other factors include the presence or absence of existing businesses in the area, the demographics of the area and so forth.

In stage 3, optionally the potential surrounding environment and geographic area are divided into a plurality of regions, including but not limited to “My Neighborhood”, “Nearby Neighborhoods”, “My City”, “Nearby Cities”, “My State”, “Nearby States” based on the willingness to travel and existing business density factors. In stage 4, one of these regions is selected for further consideration for attracting and retaining customers.

In stage 5, on-line behavior of the user is considered. For online marketing another potential signal is user behavior when searching for specific business types. One source of this type of data is as clickstream data from ISP.

In stage 6, the above potential of the business is considered with regard to the additional marketing costs required to reach new customers, for example through on-line advertising. Again, these costs are preferably analyzed in advance by business category and also for the surrounding geographical area.

In stage 7, the estimated cost for obtaining a new customer is determined from the factors analyzed in stages 1-5 and also from the costs determined in stage 6.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for generating a lexicon for modeling a document, comprising: constructing a locality related lexicon; defining a lexicon topic; modeling said topic; determining a word count of each word in a collection of related documents for said topic; eliminating stop words from word collection; forming the lexicon from the most frequently appearing terms for said topic.

2. The method of claim 1, wherein said eliminating said stop words comprises identifying stop words by locality, by topic or a combination thereof; maintaining a phrase including a stop word if said phrase is not a stop word; and eliminating any remaining stop words.

3. The method of claim 2, wherein said constructing said locality related lexicon comprises defining a language based locality.

4. The method of claim 3, wherein said defining said lexicon topic comprises determining said lexicon topic according to a cluster of a plurality of webpages identified as being related by a search engine.

5. The method of claim 4, wherein said forming the lexicon comprises weighting terms according to frequency of appearance in higher ranking web pages, such that said frequently appearing terms are defined according to a combination of frequency overall in all web pages and rank of web pages having said terms.

6. The method of claim 5, wherein said modeling said topic comprises searching for said topic in a search engine and analyzing results of said searching to model said topic.

7. The method of claim 6, wherein said analyzing said results comprises observing a frequency of singleton terms and n-grams.

8. The method of claim 7, wherein said observing said frequency comprises eliminating singleton terms that are encompassed by n-grams, and eliminating shorter n-grams that are encompassed by longer n-grams.

9. The method of claim 8, wherein said eliminating said stop words comprises determining whether a stop word is relevant to said topic;
and if said stop word is relevant to said topic, maintaining said stop word in said lexicon.

10. The method of claim 9, wherein said determining whether said stop word is relevant comprises analyzing a plurality of web pages relevant to said topic for a presence of said stop word.

11. A method for analyzing a document comprising text to predict a rank of the document according to a ranking method, the method comprising receiving a lexicon; dividing the text into non-overlapping spans; calculating features of the text according to said spans and said lexicon; and applying said features to rank prediction.

12. The method of claim 11, wherein said receiving said lexicon comprises generating said lexicon for modeling a document, comprising: constructing a locality related lexicon; defining a lexicon topic; modeling said topic; determining a word count of each word in a collection of related documents for said topic; eliminating stop words from word collection; forming the lexicon from the most frequently appearing terms for said topic.

13. The method of claim 12, wherein said dividing the text into non-overlapping spans comprises determining a size of said spans according to a threshold.

14. The method of claim 13, wherein said size of said spans is determining according to a number of words in said spans or a weight of words in said spans, or a combination thereof.

15. The method of claim 14, wherein said applying said features to rank prediction further comprises performing a method of eigenvector space mapping; and according to said mapping, providing one or more suggestions for optimal correction.

16. The method of claim 15, further comprising analyzing one or more higher order statistical features for rank prediction.

17. The method of claim 16, wherein said analyzing further comprises applying multivariate analysis.

18. The method of claim 17, wherein said higher order statistical features comprise one or more of entropy, variance, angular second moment, inverse difference moment, contrast correlation, and difference entropy.
